(19) United States
(12) Patent Application Publication
(10) Pub. No.: US 2005/0278463 A1
(43) Pub. Date: Dec. 15, 2005

(54) Information processing apparatus and power supply voltage control method

(75) Inventor: Motoaki Ando, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/137,796

(22) Filed: May 26, 2005

(30) Foreign Application Priority Data
May 28, 2004 (JP) 2004-159493

(51) Int. Cl. G06F 13/10

(52) U.S. Cl. 710/8

(57) ABSTRACT

An information processing apparatus includes a device controller which executes communication with an I/O device via a communication channel, the controller including a first internal circuit and a first input/output buffer connected to the communication channel, and the I/O device including a second internal circuit and a second input/output buffer connected to the communication channel, a power supply unit which is capable of supplying combinations of an operation voltage for driving the first and second internal circuits and an interface voltage for driving the first and second input/output buffers to the I/O device and the controller, a unit which executes an operation test with including data transfer between the I/O device and the controller with respect to a predetermined combinations of the operation voltage and the interface voltage, and a unit which selects one of the combinations based on a result of the operation test.

### CROSS-REFERENCE TO RELATED APPLICATIONS

This application is based upon and claims the benefit of priority from prior Japanese Patent Application No. 2004-159493, filed May 28, 2004, the entire contents of which are incorporated herein by reference.

### BACKGROUND OF THE INVENTION

1. Field of the Invention

The present invention relates to an information processing apparatus such as a personal computer, and a power supply voltage control method used in the apparatus.

2. Description of the Related Art

In general, information processing apparatuses such as personal computers adopt various power saving techniques. Jpn. Pat. Appln. KOKAI Publication No. 2003-271267 discloses a power saving technique that lowers the clock frequency and power supply voltage reduce supplied to a processor.

A personal computer uses various I/O devices as its components. Respective I/O devices are connected to device controllers via communication channel such as cables and buses. In order to achieve power saving and on a personal computer, not only the power consumption power of the processor but also that consumed by respective I/O devices must be reduced.

Each I/O device has an internal circuit for implementing a specific function, and input/output buffers used to communicate with a device controller. However, the same power supply voltage is commonly supplied to the internal circuit and input/output buffers in the I/O device.

For this reason, if the power supply voltage supplied to an I/O device is reduced, not only the power supply voltage to the internal circuit in the I/O device but also that to the input/output buffers in the I/O device are reduced. As a result, the signal line drive performance of the input/output buffers drops.

Hence, when the power supply voltage to the I/O device is simply reduced, data transfer between the I/O device and device controller cannot be executed normally depending on a connection environment (e.g., the length or type of communication channel) between the I/O device and device controller. Therefore, it is required to implement a function that optimizes a combination of a power supply voltage to the input/output buffers and that to the internal circuit.

### BRIEF SUMMARY OF THE INVENTION

According to an embodiment of the present invention, there is provided an information processing apparatus comprising a device controller which executes communication with an I/O device via a communication channel, the device controller including a first internal circuit and a first input/output buffer connected to the communication channel, and the I/O device including a second internal circuit and a second input/output buffer connected to the communication channel; a power supply unit which is capable of supplying combination of an operation power supply voltage for driving the first and second internal circuits and an interface power supply voltage for driving the first and second input/output buffers to the I/O device and the device controller; means for executing an operation test associated with data transfer between the I/O device and the device controller with respect to a predetermined combinations of an operation power supply voltage and an interface power supply voltage; and means for selecting one of the combinations based on a result of the operation test.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below serve to explain the principles of the invention.

FIG. 1 is a block diagram showing the system arrangement of a computer according to an embodiment of the present invention;

FIG. 2 is a block diagram showing an example of the connection arrangement between a device controller and device in the computer shown in FIG. 1;

FIG. 3 is a block diagram showing another example of the connection arrangement between a device controller and device in the computer shown in FIG. 1;

FIG. 4 is a block diagram showing an example of the arrangement of a device used in the computer shown in FIG. 1;

FIG. 5 is a block diagram showing still another example of the connection arrangement between a device controller and device in the computer shown in FIG. 1;

FIG. 6 is a view for explaining the transfer rates, interface voltages, and operation voltages that can be used in the computer shown in FIG. 1;

FIG. 7 is a view for explaining the tendencies of the transfer rate, consumption power, and stability corresponding to the interface voltage, and those corresponding to the operation voltage;

FIG. 8 is a view showing the evaluation results of the transfer rate, consumption power, and stability in association with a plurality of combinations of the interface voltages and operation voltages;

FIG. 9 is a flowchart showing the sequence of a transfer rate setting process executed by the computer shown in FIG. 1;

FIG. 10 is a flowchart showing the sequence of an interface voltage setting process executed by the computer shown in FIG. 1;

FIG. 11 is a flowchart showing the sequence of an operation voltage setting process executed by the computer shown in FIG. 1;

FIG. 12 is a flowchart showing the sequence of a transfer rate speedup process executed by the computer shown in FIG. 1;

FIG. 13 is a flowchart showing a first example of the sequence of a power saving process executed by the computer shown in FIG. 1;

FIG. 14 is a flowchart showing a second example of the sequence of a power saving process executed by the computer shown in FIG. 1;

FIG. 15 is a flowchart showing an example of the sequence of a process for determining an optimal combination of transfer rate, interface voltage, and operation voltage, which is executed by the computer shown in FIG. 1;

FIG. 16 shows an example of a test result table used in the computer shown in FIG. 1; and

FIG. 17 is a flowchart for explaining the sequence executed upon power on the computer shown in FIG. 1.

### DETAILED DESCRIPTION OF THE INVENTION

A preferred embodiment of the present invention will be described hereinafter with reference to the accompanying drawings.

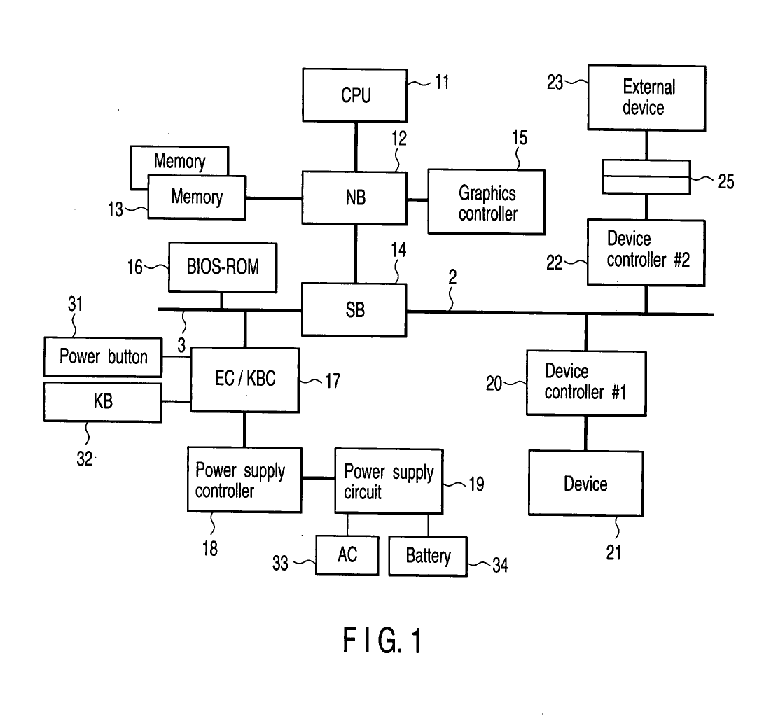

FIG. 1 shows the system arrangement of an information processing apparatus according to an embodiment of the present invention. This information processing apparatus is implemented as, e.g., a battery-driven notebook-type personal computer.

As shown in FIG. 1, this computer comprises a central processing unit (CPU) 11, north bridge (NB) 12, main memory 13, south bridge (SB) 14, graphics controller 15, BIOS-ROM 16, embedded controller/keyboard controller IC (EC/KBC) 17, power supply controller 18, power supply circuit 19, first device controller 20, device 21, and second device controller 22.

The CPU 11 is a processor which is provided to control the operation of the computer, and executes an operating system and various application programs loaded into the main memory 13. The CPU 11 also executes a basic input output system (BIOS) stored in the BIOS-ROM 16. The BIOS is a system program for hardware control.

The north bridge 12 is a bridge device which connects between a local bus 1 of the CPU 11 and the south bridge 14. This north bridge 12 incorporates a memory controller that controls access to the main memory 13. The graphics controller 15 controls a display device (e.g., a flat-panel display such as a liquid crystal display (LCD) used as a display monitor of this computer. The graphics controller 15 has a video memory (VRAM) and displays display data rendered in the video memory by the operating system application programs.

The south bridge 14 controls respective devices on a peripheral component interconnect (PCI) bus 2 and those on an LPC (Low pin count) bus 3. On the PCI bus 2, the first and second device controllers 20 and 22 are connected.

The first device controller 20 executes communication with the device 21 and controls that device 21 under the control of the CPU 11. The device 21 is an I/O device such as an Integrated Drive Electronics (IDE) device or universal serial bus (USB) device. The second device controller 22 controls an external device 23 under the control of the CPU 11. The external device 23 is an optional I/O device which is detachably connected to a connector 25 provided on the main body of the computer, and includes an IDE device, and USB device.

On the LPC bus 3, the embedded controller/keyboard controller IC (EC/KBC) 17 is connected. The embedded controller/keyboard controller IC (EC/KBC) 17 is a single-chip microcomputer that integrates an embedded controller for power management, and a keyboard controller for controlling a keyboard (KB) 32. This embedded controller/keyboard controller IC (EC/KBC) 17 has a function of turning on/off the computer in response to an operation of a power button 31 by the user. The embedded controller/keyboard controller IC (EC/KBC) 17 also has a function of executing communication with the power supply controller 18. The power supply controller 18 controls the power supply circuit 19 under the control of the embedded controller/keyboard controller IC (EC/KBC) 17. The power supply circuit 19 generates an operation power supply voltage to be supplied to respective components that form the computer from an AC power supply (external power supply) 33 or internal battery 34.

The power supply circuit 19 is a power supply unit configured to supply two different types of power supply voltages, i.e., an operation power supply voltage and interface power supply voltage, to the first device controller 20 and device 21. The operation power supply voltage is a power supply voltage to be supplied to internal circuits of the first device controller 20 and device 21. The interface power supply voltage is a power supply voltage to be supplied to input/output buffers in the first device controller 20 and device 21. Also, the power supply circuit 19 supplies two different types of power supply voltages, i.e., an operation power supply voltage and interface power supply voltage, to the second device controller 22 and external device 23.

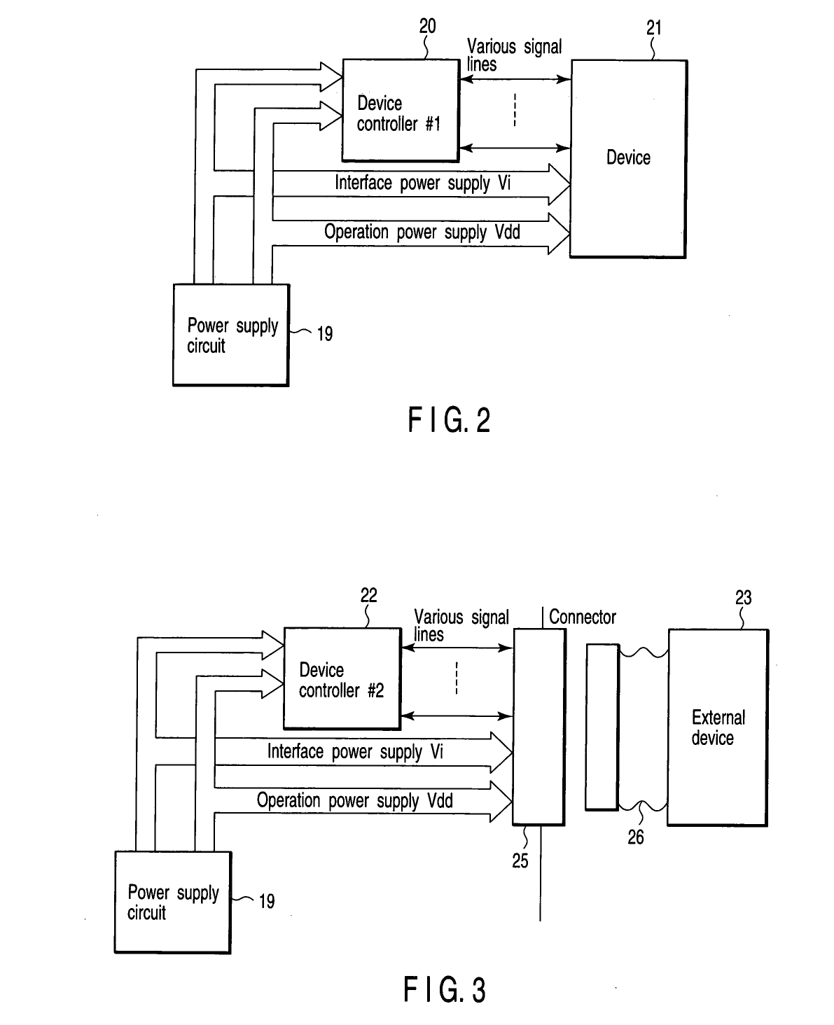

FIG. 2 shows the connection arrangement between the first device controller 20 and device 21. Various signals are connected between the first device controller 20 and device 21. A communication between the first device controller 20 and device 21 is made via a communication channel formed by these signal lines. This communication channel is realized by a cables, buses or the like. The rate of data transfer executed between the first device controller 20 and device 21 via the communication path can be changed by controlling, e.g., the frequency of a clock signal supplied to the first device controller 20 and device 21. The power supply circuit 19 outputs an operation power supply voltage Vdd and interface power supply voltage Vi as power supply voltages to the first device controller 20 and device 21. The operation power supply voltage Vdd from the power supply circuit 19 is commonly supplied to both the first device controller 20 and device 21. Likewise, the interface power supply voltage Vi is commonly supplied to both the first device controller 20 and device 21.

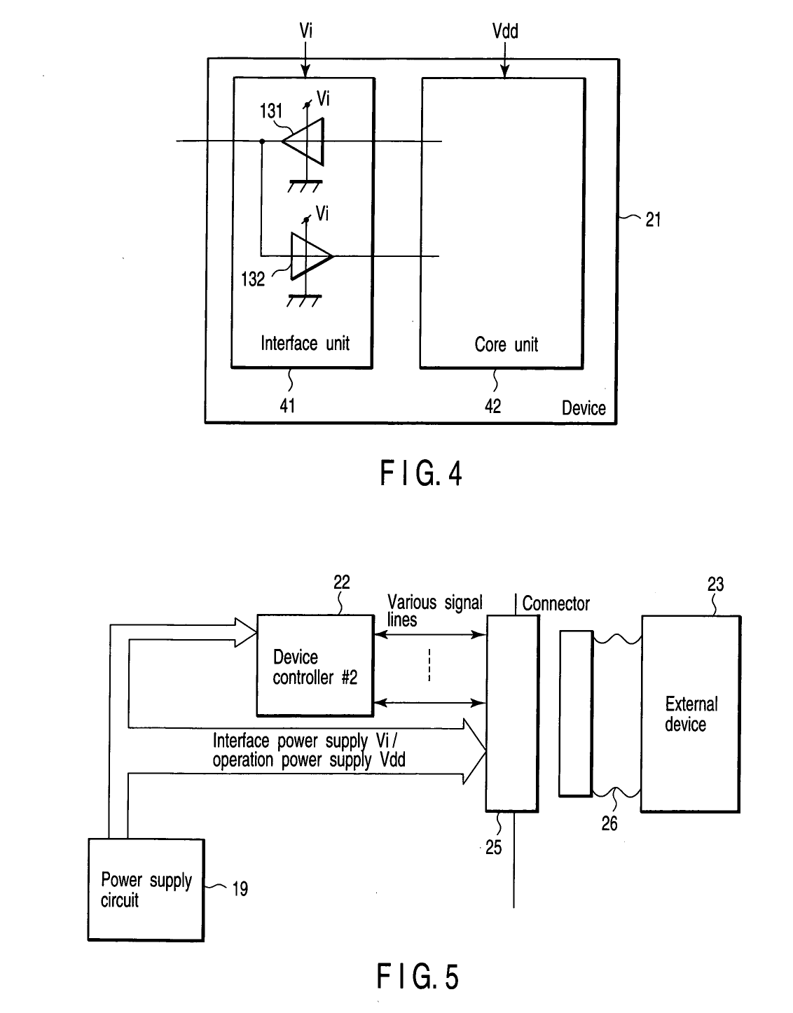

As shown in FIG. 4, the device 21 comprises an interface unit 41 and core unit 42. The interface unit 41 communicates with the first device controller 20 via the communication channel. The interface unit 41 comprises an input buffer 131 and output buffer 132, which are respectively connected to the communication channel. The interface power supply voltage Vi is supplied to these input buffer 131 and output buffer 132 as a power supply voltage for driving the input buffer 131 and output buffer 132. The core unit 42 is an internal circuit required to implement the function of the device 21. The operation power supply voltage Vdd is supplied to the core unit 42 as a power supply voltage for driving the core unit 42.

The second device controller 20 includes input/output buffers connected to the communication channel, and a core unit, as in the device 21. The input/output buffers receive the interface power supply voltage Vi, and the core unit receives the operation power supply voltage Vdd.

FIG. 3 shows the connection arrangement between the second device controller 22 and external device 23. The external device 23 is connected to the connector 25 via a cable 26. Various signal lines are connected between the second device controller 22 and connector 25. Communication between the second device controller 22 and external device 23 is executed via a communication path formed by these signal lines, the connector 25, and the cable 26. The power supply circuit 19 outputs an operation power supply voltage Vdd and interface power supply voltage Vi as power supply voltages to the second device controller 22 and external device 23. The operation power supply voltage Vdd from the power supply circuit 19 is commonly supplied to both the second device controller 22 and external device 23. Likewise, the interface power supply voltage Vi is commonly supplied to both the second device controller 22 and external device 23.

FIG. 5 shows another example of the connection arrangement between the second device controller 22 and external device 23. The external device 23 incorporates a voltage regulator device which generates two different types of power supply voltages, i.e., an operation power supply voltage Vdd and interface power supply voltage Vi, from a power supply voltage supplied from the power supply circuit 19. This voltage regulator circuit can variably set the values of the operation power supply voltage Vdd and interface power supply voltage Vi to be generated in accordance with, e.g., a command from the second device controller 22.

A method of optimizing a combination of the operation power supply voltage Vdd and interface power supply voltage Vi will be explained below.

In the following description, a case will be exemplified wherein a combination of the operation power supply voltage Vdd and interface power supply voltage Vi to be respectively supplied to the first device controller 20 and device 21 is to be optimized.

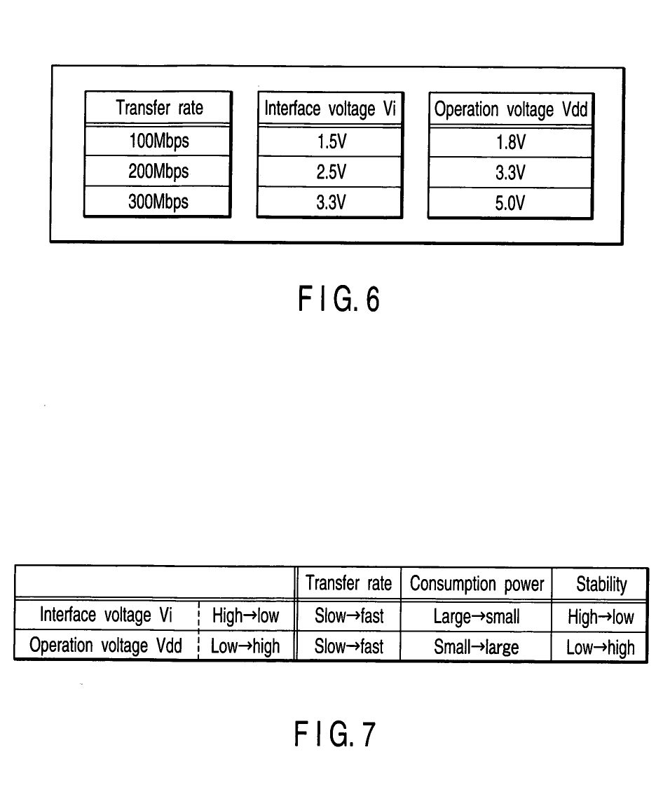

The values of the operation power supply voltage Vdd, interface power supply voltage Vi, and data transfer rate between the first device controller 20 and device 21 will be described first with reference to FIG. 6.

In this embodiment, assume that the rate of data transfer (to be referred to as transfer rate hereinafter) to be executed between the first device controller 20 and device 21 can be set to be an arbitrary one of three different rates of 100, 200, and 300 Mbps. Assume that the power supply circuit 19 can output three different values, e.g., 1.5V, 2.5V, and 3.3V, of the interface power supply voltage Vi (to be referred to as an interface voltage hereinafter). Also, assume that the power supply circuit 19 can output three different values, e.g., 1.8V, 3.3V, and 5.0V, of the operation power supply voltage Vdd (to be referred to as an operation voltage hereinafter).

FIG. 7 shows the tendencies of the transfer rate, consumption power, and stability corresponding to the interface voltage, and those corresponding to the operation voltage.

The amplitude of a signal flowing on the communication channel decreases with decreasing value of the interface voltage. Since the time required for transition of the logical of the signal can become shorter with decreasing amplitude level of the signal, the transfer rate can be easily speeded up accordingly. Therefore, the tendency of the transfer rate depending on the interface voltage is expressed by:
Interface voltage (high→low): transfer rate (slow→fast)

Also, the tendency of the consumption power depending on the interface voltage is expressed by:
Interface voltage (high→low): consumption power (large→small)

The noise margin decreases with decreasing amplitude of the signal. Therefore, the tendency of the stability of the operation depending on the Interface voltage is expressed by:
Interface voltage (high→low): stability (high→low)

The tendency of the transfer rate depending on the operation voltage is expressed by:
Operation voltage (low→high): transfer rate (slow→fast)

The tendency of the consumption power depending on the operation voltage is expressed by:
Operation voltage (low→high): consumption power (small→large)

The tendency of the stability depending on the operation voltage is expressed by:
Operation voltage (low→high): stability (low→high)

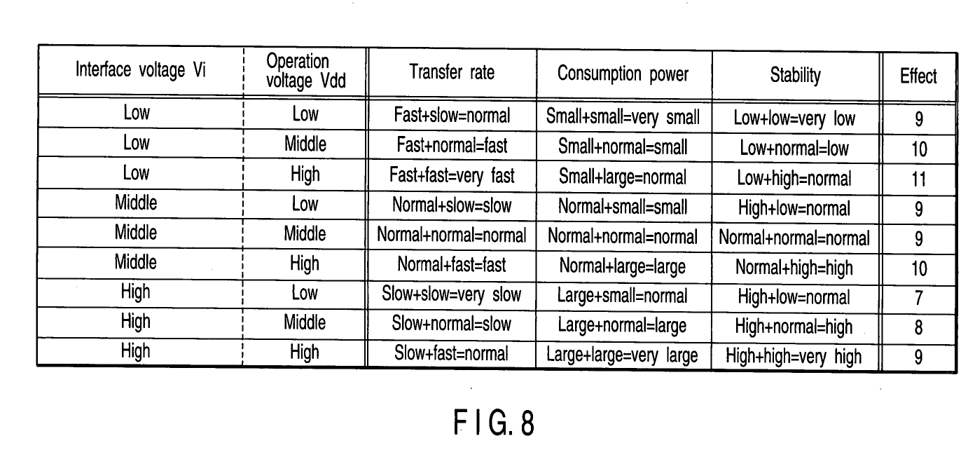

FIG. 8 shows the evaluation results of the transfer rate, consumption power, and stability in association with a plurality of combinations of interface voltages and operation voltages. In FIG. 8, each of the transfer rate, consumption power, and stability is evaluated in five levels. More specifically, the transfer rate is evaluated in five levels “very slow”, “slow”, “normal”, “fast”, and “very fast”. Scores corresponding to these levels “very slow”, “slow”, “normal”, “fast”, and “very fast” are respectively “1”, “2”, “3”, “4”, and “5”. The consumption power is evaluated in five levels “very large”, “large”, “normal”, “small”, and “very small”. Scores corresponding to these levels “very large”, “large”, “normal”, “small”, and “very small” are respectively “1”, “2”, “3”, “4”, and “5”. The stability is evaluated in five levels “very low”, “low”, “normal”, “high”, and “very high”. Scores corresponding to these levels “very low”, “low”, “normal”, “high”, and “very high” are respectively “1”, “2”, “3”, “4”, and “5”. Also, an [effect] field in FIG. 8 indicates a total value of the scores of the transfer rate, consumption power, and stability as a total evaluation value.

As can be seen from FIG. 8, there is no combination of the interface voltage and operation voltage that can attain full marks (15 points) of the total evaluation value. Hence, a more optimal combination of the interface voltage and operation voltage must be selected in consideration of an actual connection environment between the first device controller 20 and device 21.

In this embodiment, the following process is executed under the control of the BIOS so as to select an optimal combination of the interface voltage and operation voltage.

(Step 1) Operation test: The BIOS conducts an operation test associated with data transfer between the first device controller 20 and device 21 while changing the combination of the interface voltage and operation voltage. In this operation test, data transfer for a test is executed for each combination of the interface voltage and operation voltage.

(Step 2) Select optimal combination: The BIOS selects one combination to be actually used in an operation mode from a plurality of combinations of the interface voltages and operation voltages based on a result of the operation test. In this case, if a reduction of the consumption power is selected in preference to the transfer rate, a combination with the lowest operation voltage is selected from those which can execute data transfer normally. As for the consumption power of the device, that of the operation voltage is relatively larger than the interface voltage. In a device whose internal circuit requires smaller consumption power, the consumption power of the interface voltage of that device may become larger than the operation voltage (e.g., a semiconductor storage device connected to an IDE cable). At this time, a combination with the lowest interface voltage is selected from those which can execute data transfer normally.

If speeding up of the transfer rate is selected in preference to a reduction of the consumption power, the BIOS executes the operation test associated with data transfer between the first device controller 20 and device 21 while changing the combination of the transfer rate, interface voltage, and operation voltage in step 1. In step 2, the BIOS selects a combination of the interface voltage and operation voltage that can execute highest-speed data transfer from a plurality of combinations of the interface voltages and operation voltages on the basis of the operation test results.

Some processes to be executed in the sequence for selecting an optimal combination of the interface voltage and operation voltage will be explained below.

(Transfer Rate Setting Process)

The transfer rate setting process is a process for determining the upper and lower limits of the transfer rate that can be used with a given combination of the interface voltage and operation voltage.

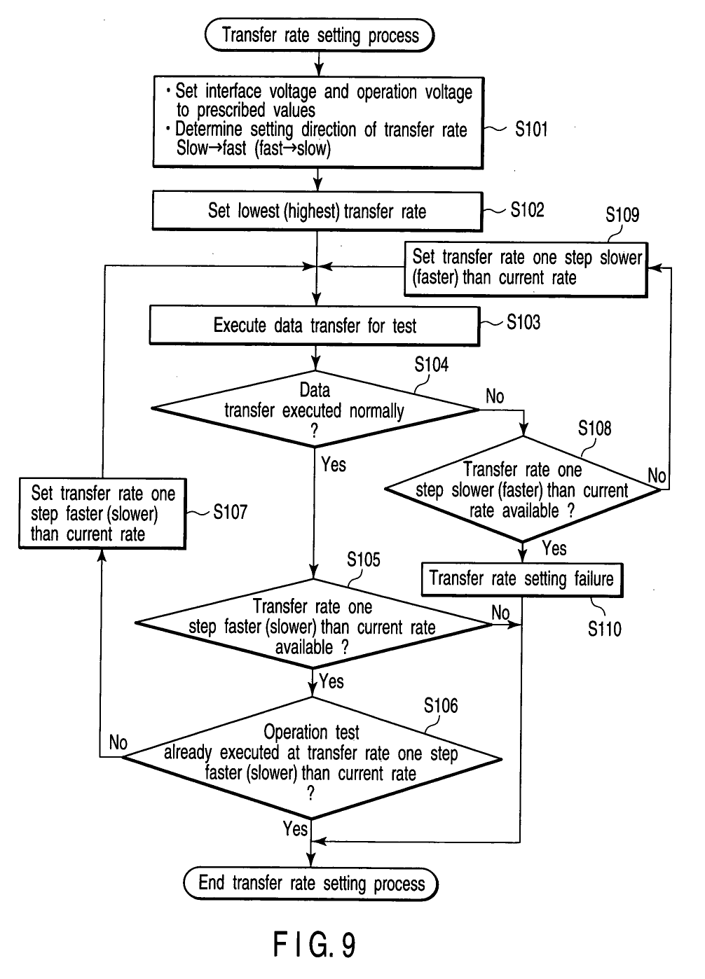

The sequence of the transfer rate setting process will be described below with reference to the flowchart of FIG. 9. The BIOS sets the interface and operation voltage to be given prescribed values, and determines a direction (slow→fast or fast→slow) to change the transfer rate (step S101). Assume that the direction to change the transfer rate is set to be “slow→fast” in the following description.

The BIOS sets the lowest one (100 Mbps) of the transfer rates of data transfer to be executed between the first device controller 20 and device 21 (step S102). In step S102, the BIOS executes a process for, e.g., setting the frequency of clock signals to be supplied to the first device controller 20 and device 21 to be a value corresponding to the lowest transfer rate. The BIOS then controls the first device controller 20 to execute an operation test associated with data transfer between the first device controller 20 and device 21 (step S103). In step S103, the BIOS executes the operation test associated with data transfer between the first device controller 20 and device 21, i.e., data transfer for a test conducted to check if data transfer can be done normally between the first device controller 20 and device 21. The BIOS checks if the data transfer for the test can be normally executed (step S104).

If the data transfer for the test can be executed normally (YES in step S104), the BIOS checks if a transfer rate one step higher than the current one is available (step S105). If the transfer rate one step higher than the current one is available (YES in step S105), the BIOS checks if the operation test has already been done at that transfer rate one step higher than the current one (step S106). If the operation test has not been done yet at that transfer rate one step higher than the current one (NO in step S106), the BIOS sets the transfer rate of data transfer to be executed between the first device controller 20 and device 21 to be a transfer rate one step higher than the current one (step S107). The BIOS executes an operation test associated with the data transfer between the first device controller 20 and device 21 (step S103).

If the data transfer for the test cannot be executed normally (NO in step S104), the BIOS checks if a transfer rate one step lower than the current one is available (step S108). If no transfer rate one step lower than the current one is available, i.e., if the current transfer rate is the lowest one (YES in step S108), the transfer rate setting process fails (step S110). If the transfer rate one step lower than the current one is available (NO in step S108), the BIOS sets the transfer rate of data transfer to be executed between the first device controller 20 and device 21 to be the transfer rate one step lower than the current one (step S109). The BIOS controls the first device controller 20 to execute an operation test associated with the data transfer between the first device controller 20 and device 21 (step S103). If the data transfer for the test can be executed normally (YES in step S104), the BIOS checks if a transfer rate one step higher than the current one is available (step S105). If the transfer rate one step higher than the current one is available (YES in step S105), the BIOS checks if the operation test has already been done at that transfer rate one step higher than the current one (step S106). If the operation test has already been done at that transfer rate one step higher than the current one (YES in step S106), the BIOS ends the transfer rate setting process.

In this way, a maximum transfer rate that can be used in combination with a given interface voltage and operation voltage is specified.

(Interface Voltage Setting Process)

The interface voltage setting process is a process for determining the upper and lower limits of the interface voltage that can be used in combination with a given transfer rate and operation voltage.

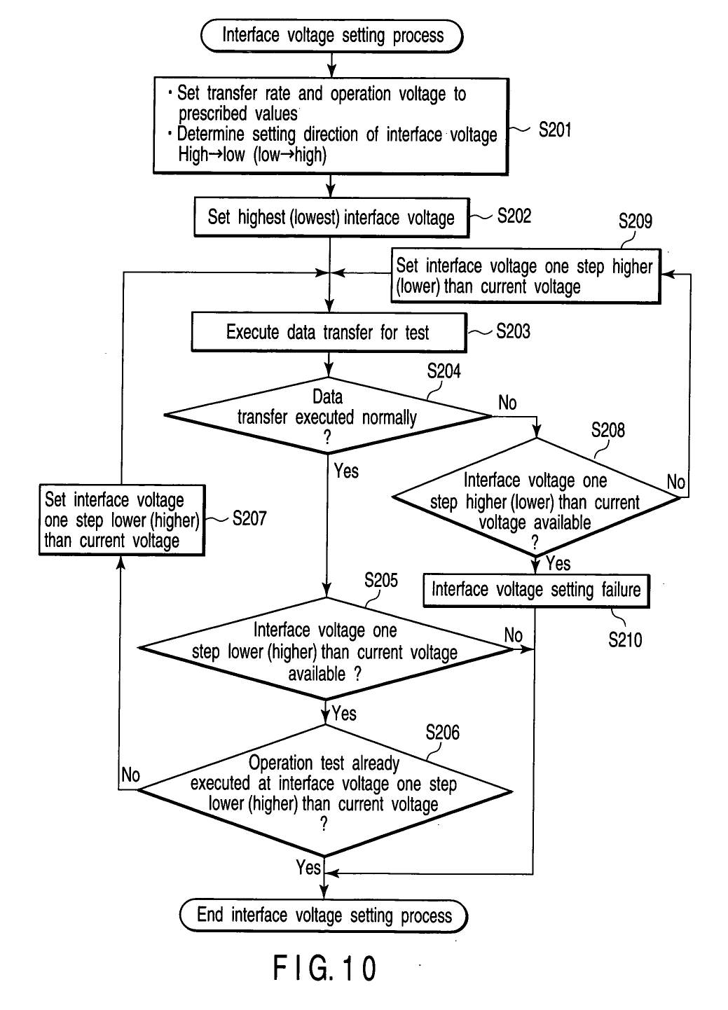

The sequence of the interface voltage setting process will be described below with reference to the flowchart of FIG. 10. The BIOS sets the transfer rate and operation voltages to be given prescribed values, and determines a direction (high→low or low→high) to change the interface voltage (step S201). Assume that the direction to change the interface voltage is set to be “high→low” in the following description.

The BIOS controls the power supply circuit 19 via the power supply controller 18 to set the interface voltage to be the highest value (3.3V) (step S202). The BIOS controls the first device controller 20 to execute an operation test associated with data transfer between the first device controller 20 and device 21 (step S203).

In step S203, the BIOS executes the operation test associated with data transfer between the first device controller 20 and device 21, i.e., data transfer for a test conducted to check if data transfer can be done normally between the first device controller 20 and device 21.

If the data transfer for the test can be normally executed (YES in step S204), the BIOS checks if an interface voltage one step lower than the current one is available (step S205). If an interface voltage one step lower than the current one is available (YES in step S205), the BIOS checks if the operation test has already been done at that interface voltage one step lower than the current one (step S206). If the operation test has not been done yet at that interface voltage one step lower than the current one (NO in step S206), the BIOS sets the interface voltage one step lower than the current one (step S207). The BIOS controls the first device controller 20 to execute an operation test associated with the data transfer between the first device controller 20 and device 21 (step S203).

On the other hand, if the data transfer for the test cannot be executed normally (NO in step S204), the BIOS checks if an interface voltage one step higher than the current one is available (step S208). If no interface voltage one step higher than the current one is available, i.e., if the current interface voltage is the highest one (YES in step S208), the interface voltage setting process fails (step S210). If an interface voltage one step higher than the current one is available (NO in step S208), the BIOS sets the interface voltage one step higher than the current one (step S209). The BIOS controls the first device controller 20 to execute an operation test associated with the data transfer between the first device controller 20 and device 21 (step S203). If the data transfer for the test can be executed normally (YES in step S204), the BIOS checks if an interface voltage one step lower than the current one is available (step S205). If an interface voltage one step lower than the current one is available (YES in step S205), the BIOS checks if the operation test has already been done at that interface voltage one step lower than the current one (step S206). If the operation test has already been done at that interface voltage one step lower than the current one (YES in step S206), the BIOS ends the interface voltage setting process.

In this way, a minimum interface voltage that can be used in combination with a given transfer rate and operation voltage is specified.

(Operation Voltage Setting Process)

The operation voltage setting process is a process for determining the upper and lower limits of the operation voltage that can be used in combination with a given transfer rate and interface voltage.

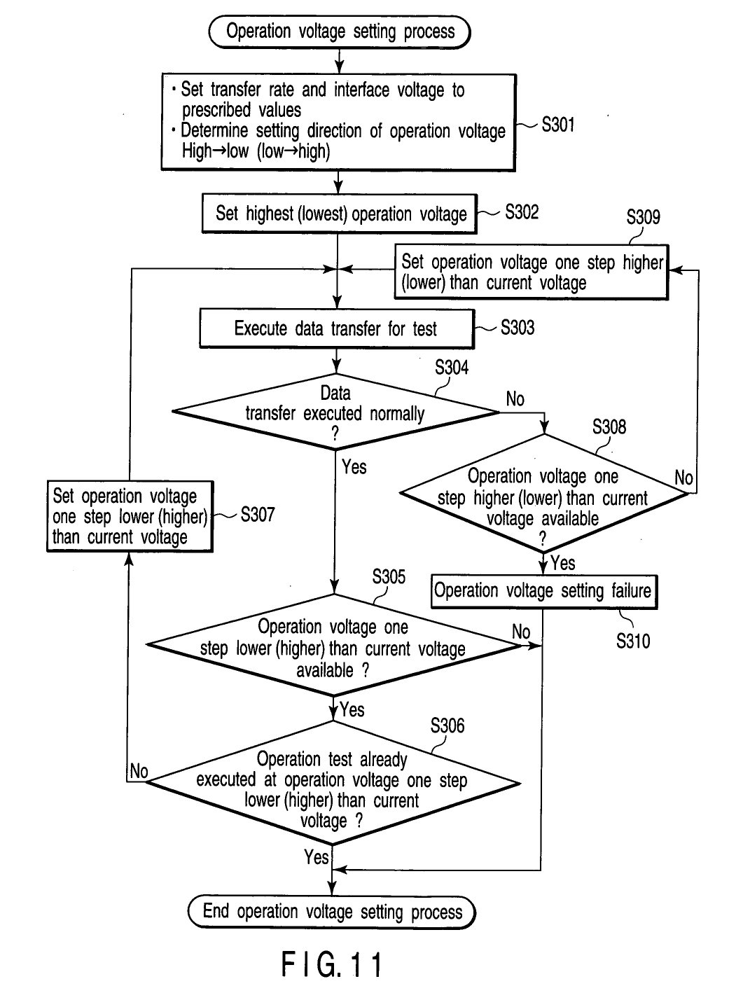

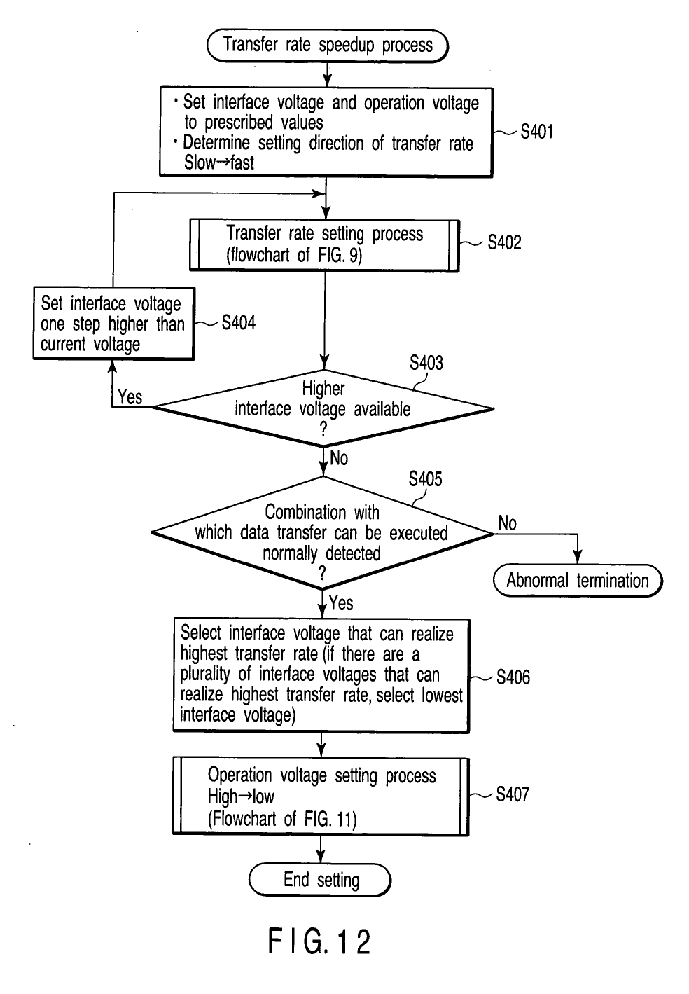

The sequence of the operation voltage setting process will be described below with reference to the flowchart of FIG. 11. The BIOS sets the transfer rate and interface voltage to be given prescribed values, and determines a direction (high→low or low→high) to change the operation voltage (step S301). Assume that the direction to change the operation voltage is set to be “high→low” in the following description.

The BIOS controls the power supply circuit 19 via the power supply controller 18 to set the operation voltage value to be the highest value (5.0V) (step S302). The BIOS controls the first device controller 20 to execute an operation test associated with data transfer between the first device controller 20 and device 21 (step S303).

In step S303, the BIOS executes the operation test associated with data transfer between the first device controller 20 and device 21, i.e., data transfer for a test conducted to check if data transfer can be done normally between the first device controller 20 and device 21.

If the data transfer for the test can be executed normally (YES in step S304), the BIOS checks if an operation voltage one step lower than the current one is available (step S305). If an operation voltage one step lower than the current one is available (YES in step S305), the BIOS checks if the operation test has already been done at that operation voltage one step lower than the current one (step S306). If the operation test has not been done yet at that operation voltage one step lower than the current one (NO in step S306), the BIOS sets the operation voltage one step lower than the current one (step S307). The BIOS controls the first device controller 20 to execute an operation test associated with the data transfer between the first device controller 20 and device 21, i.e., data transfer for a test between the first device controller 20 and device 21 (step S303).

On the other hand, if the data transfer for the test cannot be executed normally (NO in step S304), the BIOS checks if an operation voltage one step higher than the current one is available (step S308). If no operation voltage one step higher than the current one is available, i.e., if the current operation voltage is the highest one (YES in step S308), the operation voltage setting process fails (step S310). If an operation voltage one step higher than the current one is available (NO in step S308), the BIOS sets the operation voltage to be a value one step higher than the current one (step S309). The BIOS controls the first device controller 20 to execute an operation test associated with the data transfer between the first device controller 20 and device 21 (step S303). If the data transfer for the test can be normally executed (YES in step S304), the BIOS checks if an operation voltage one step lower than the current one is available (step S305). If an operation voltage one step lower than the current one is available (YES in step S305), the BIOS checks if the operation test has already been done at that operation voltage one step lower than the current one (step S306). If the operation test has already been done at that operation voltage one step lower than the current one (YES in step S306), the BIOS ends the operation voltage setting process.

In this way, the minimum operation voltage that can be used in combination with a given transfer rate and interface voltage is specified.

A process for determining an optimal combination of three parameters (transfer rate, interface voltage, and operation voltage) will be described below. Optimization is executed according to one of transfer rate priority policy and power saving priority policy.

(Transfer Rate Speedup Process)

The transfer rate speedup process is a process for determining an optimal combination of the transfer rate, interface voltage, and operation voltage according to the transfer rate priority policy.

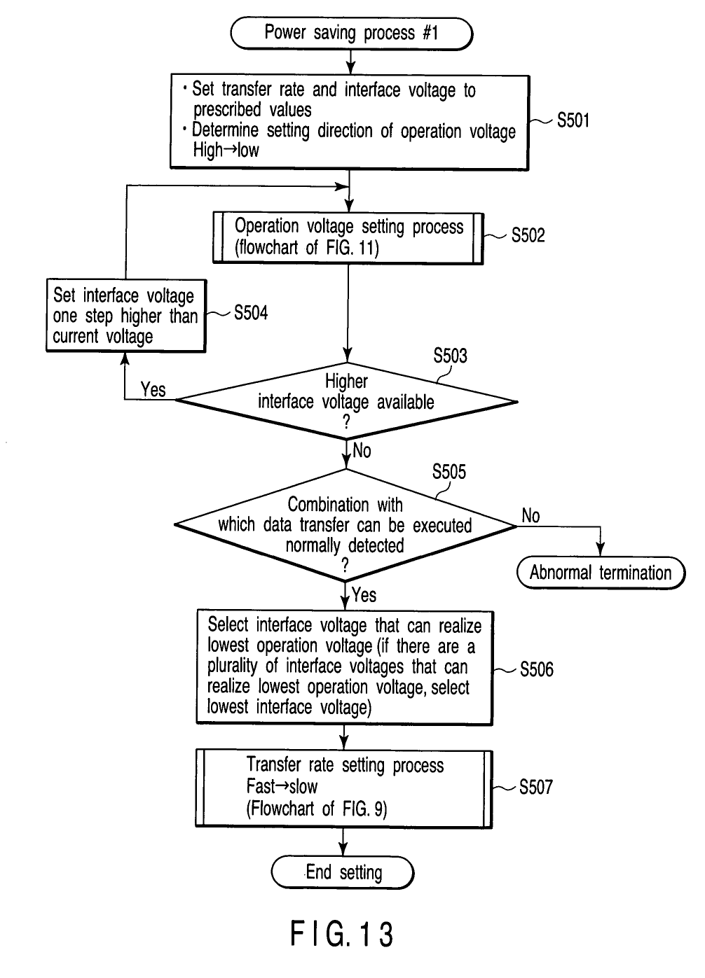

The sequence of the transfer rate speedup process will be described below with reference to the flowchart of FIG. 12.

The BIOS sets the interface voltage and operation voltages to be given prescribed values, and determines a direction to change the transfer rate (step S401). As described above, the data transfer can be executed at high speed when the interface voltage is low and the operation voltage is high, i.e., when the interface voltage is relatively lower than the operation voltage. Therefore, in step S401 the interface voltage=1.5V and operation voltage=5V are set. Also, the direction to change the transfer rate is set to be “slow→fast”.

The BIOS starts the transfer rate setting process that has been explained using the flowchart of FIG. 9 (step S402). Since the direction to change the transfer rate is “slow→fast”, the operation test is executed first while transfer rate=100 Mbps is set in the transfer rate setting process in step S402. If the data transfer is executed normally while transfer rate=100 Mbps is set, the operation test is executed in turn while transfer rate=200 Mbps is set. If an data transfer is executed normally while transfer rate=200 Mbps is set, the operation test is further executed while transfer rate=300 Mbps is set.

After that, the BIOS checks if an interface voltage one step higher than the current interface voltage is available (step S403). If an interface voltage one step higher than the current interface voltage is available (YES in step S403), the BIOS sets the interface voltage one step higher than the current one (step S404), and then executes the transfer rate setting process in step S402.

In this manner, the transfer rate setting process in step S402 is repeated while changing the interface voltage value step by step. As a result, the transfer rates which can be used in cases of:
(1) Operation voltage=5V, interface voltage=1.5V
(2) Operation voltage=5V, interface voltage=2.5V
(3) Operation voltage=5V, interface voltage=3.3V are determined. For example,
(1) when operation voltage=5V and interface voltage=1.5V, normal operations are assured at transfer rates=100 Mbps, 200 Mbps, and 300 Mbps;
(2) when operation voltage=5V and interface voltage=2.5V, normal operations are assured at transfer rates=100 Mbps and 200 Mbps; and
(3) when operation voltage=5V and interface voltage=3.3V, normal operation is assured at transfer rate=100 Mbps.

If no interface voltage one step higher than the current interface voltage is available, i.e., an interface voltage one step higher than the current interface voltage cannot be set (NO in step S403), the BIOS determines combinations that can execute data transfer normally from a plurality of combinations of the operation voltages, interface voltages, and transfer rates (step S405).

If the combinations that can execute data transfer normally are determined (YES in step S405), the BIOS selects a combination of interface voltage that can realize the highest transfer rate, and transfer rate at that time from the determined combinations (step S406).

That is, in steps S405 and S406 the BIOS selects a combination of the interface voltage that can realize the highest transfer rate, and the transfer rate at that time from combinations of the operation voltages, interface voltages, and transfer rates, which can execute normally data transfer. In the above test result examples, since data transfer is executed normally at the transfer rate=300 Mbps when the interface voltage=1.5V, a combination of the interface voltage=1.5V and the transfer rate=300 Mbps is selected. If there are a plurality of interface voltage values that can realize the highest transfer rate, the lowest interface voltage value is selected.

The BIOS executes the operation voltage setting process described using the flowchart of FIG. 11 (step S407). In step S407, the operation voltage setting process starts while the interface voltage=1.5V and the transfer rate=300 Mbps are set, and the direction to change the operation voltage is set to be “high→low”. With this operation voltage setting process, the minimum value of the operation voltage that can execute normally data transfer at the interface voltage=1.5V and the transfer rate=300 Mbps is determined. If data transfer can be executed normally at the operation voltage=3.3V but it cannot be executed normally at the operation voltage=1.5V, the operation voltage=3.3V is determined as its minimum value that can normally execute data transfer at the interface voltage=1.5V and the transfer rate=300 Mbps. As a result, a combination of the interface voltage=1.5V, the transfer rate=300 Mbps, and the operation voltage=3.3V is determined as an optimal combination.

The BIOS controls the power supply circuit 19 to set the interface voltage=1.5V, and the operation voltage=3.3V, and sets the transfer rate of data transfer to be executed between the first device controller 20 and device 21 to be 300 Mbps.

(Power Saving Process)

The power saving process is a process for determining an optimal combination of the transfer rate, interface voltage, and operation voltage according to the power saving priority policy.

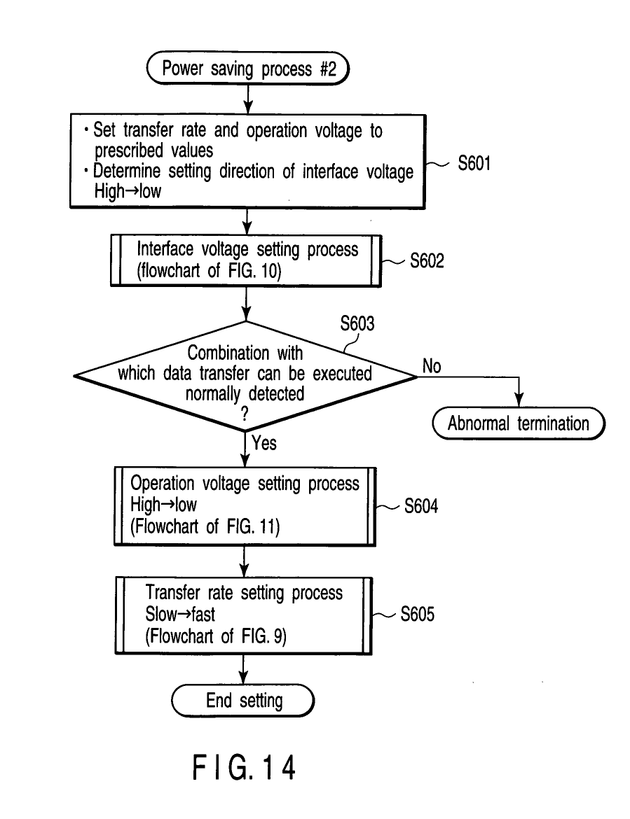

The first example of the power saving process will be explained below with reference to the flowchart of FIG. 13. The power saving process in FIG. 13 is used when the operation voltage requires larger device consumption power than the interface voltage.

The BIOS sets the transfer rate and interface voltages to be given prescribed values, and determines a direction (high→low or low→high) to change the operation voltage (step S501). The device consumption power is smaller with decreasing transfer rate. On the other hand, the device consumption power is smaller with decreasing interface voltage. Hence, in step S501 the transfer rate=100 Mbps and interface voltage=1.5V are set. Also, the direction to change the operation voltage is set to be “high→low”.

Next, the BIOS executes the operation voltage setting process that has been explained in the flowchart of FIG. 11 (step S502). Since the direction to change the operation voltage is “high→low”, the operation test is executed first while the operation voltage=5V is set in the operation voltage setting process in step S502. If the data transfer is executed normally while the operation voltage=5V is set, the operation test is executed in turn while the operation voltage=3.3V is set. If the data transfer is executed normally while the operation voltage=3.3V is set, the operation test is further executed while the operation voltage=1.8V is set.

After that, the BIOS checks if an interface voltage one step higher than the current interface voltage is available (step S503). If an interface voltage one step higher than the current interface voltage is available (YES in step S503), the BIOS sets the interface voltage to be a value one step higher than the current one (step S504), and then executes the operation voltage setting process in step S502.

In this manner, the operation voltage setting process in step S502 is repeated while changing the interface voltage value step by step.

If no interface voltage one step higher than the current interface voltage is available, i.e., an interface voltage one step higher than the current interface voltage cannot be set (NO in step S503), the BIOS determines combinations that can execute data transfer normally from a plurality of combinations of the operation voltages, interface voltages, and transfer rates (step S505).

If the combinations that can execute data transfer normally are determined (YES in step S505), the BIOS selects a combination of interface voltage that can realize the lowest operation voltage, and operation voltage at that time from the determined combinations (step S506).

That is, in steps S505 and S506 the BIOS selects a combination of the interface voltage that can realize the lowest operation voltage, and the operation voltage at that time from combinations of the operation voltages, interface voltages, and transfer rates, which can execute normally data transfer. In this way, for example, a combination of the interface voltage=2.5V and the operation voltage=1.8V is selected. If there are a plurality of interface voltage values that can realize the lowest operation voltage values, a lowest interface voltage value is selected.

The BIOS executes the transfer rate setting process described using the flowchart of FIG. 9 (step S507). In step S507, the transfer rate setting process starts while the interface voltage=2.5V and the operation voltage=1.8V are set, and the direction to change the transfer rate is set to be “slow→fast”. With this transfer rate setting process, the maximum value of the transfer rate that can execute data transfer normally at the interface voltage=2.5V and the operation voltage=1.8V is determined. If data transfer cannot be executed normally at the transfer rate=200 Mbps, a combination of the interface voltage=2.5V, the operation voltage=1.8V, and the transfer rate=100 Mbps is determined as an optimal combination.

The BIOS controls the power supply circuit 19 to set the interface voltage=2.5V, and the operation voltage=1.8V, and sets the transfer rate of data transfer to be executed between the first device controller 20 and device 21 to be 100 Mbps.

The second example of the power saving process will be explained below with reference to the flowchart of FIG. 14. The power saving process in FIG. 14 is used when the interface voltage requires larger device consumption power than the operation voltage. In this power saving process, the interface voltage setting process is executed prior to the operation voltage setting process.

The BIOS sets the transfer rate and operation voltages to be given prescribed values, and determines a direction (high→low or low→high) to change the interface voltage (step S601). The device consumption power is smaller with decreasing transfer rate. On the other hand, the device consumption power is smaller with decreasing interface voltage. Hence, in step S601 the transfer rate=100 Mbps and operation voltage=1.8V are set. Also, the direction to change the interface voltage is set to be “high→low”.

Next, the BIOS executes the interface voltage setting process that has been explained in the flowchart of FIG. 10 (step S602). Since the direction to change the interface voltage is “high→low”, the operation test is executed first while the interface voltage=3.3V is set in the interface voltage setting process in step S602. If the data transfer is executed normally while the interface voltage=3.3V is set, the operation test is executed in turn while the interface voltage=2.5V is set. If the data transfer is normally executed while the interface voltage=2.5V is set, the operation test is further executed while the interface voltage=1.5V is set.

Next, the BIOS determines combinations that can execute data transfer normally from a plurality of combinations of the operation voltages, interface voltages, and transfer rates (step S603).

If the combinations that can execute the data transfer normally are selected (YES in step S603), the BIOS executes the operation voltage setting process that has been explained using the flowchart of FIG. 11 using the minimum value of the interface voltage that can execute data transfer normally when the transfer rate=100 Mbps and the operation voltage=1.8V (step S604). In step S604, a minimum value of the operation voltage that can be used under the conditions of the minimum value of the interface voltage that can be used and the transfer rate=100 Mbps is obtained. Next, the transfer rate setting process that has been explained using the flowchart of FIG. 9 is executed using the minimum values of the interface voltage and the operation voltage, which are determined in the interface and operation voltage setting processes (step S605). As a result, an optimal combination of the interface voltage, operation voltage, and transfer rate is determined.

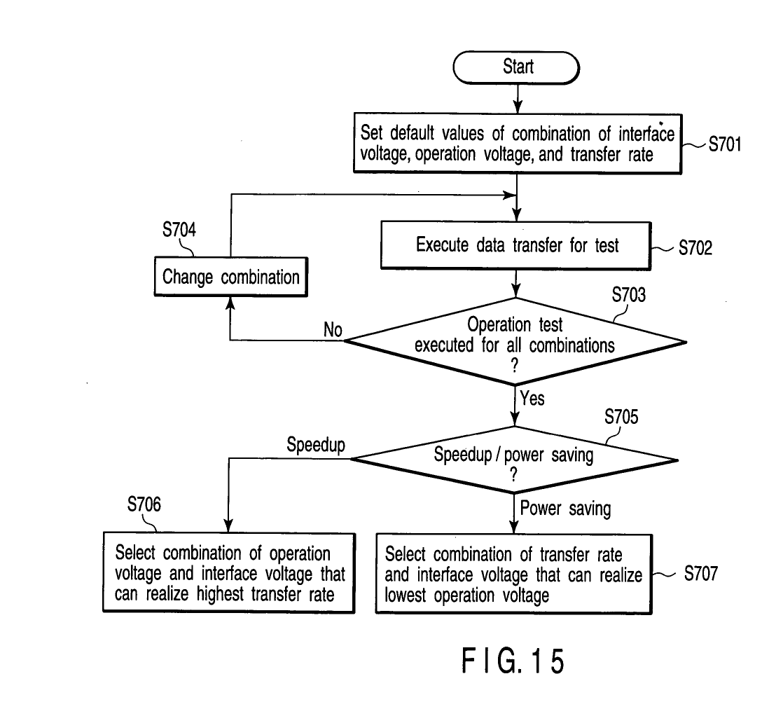

Another example of the process for determining an optimal combination of the interface voltage, operation voltage, and transfer rate will be described below with reference to the flowchart of FIG. 15.

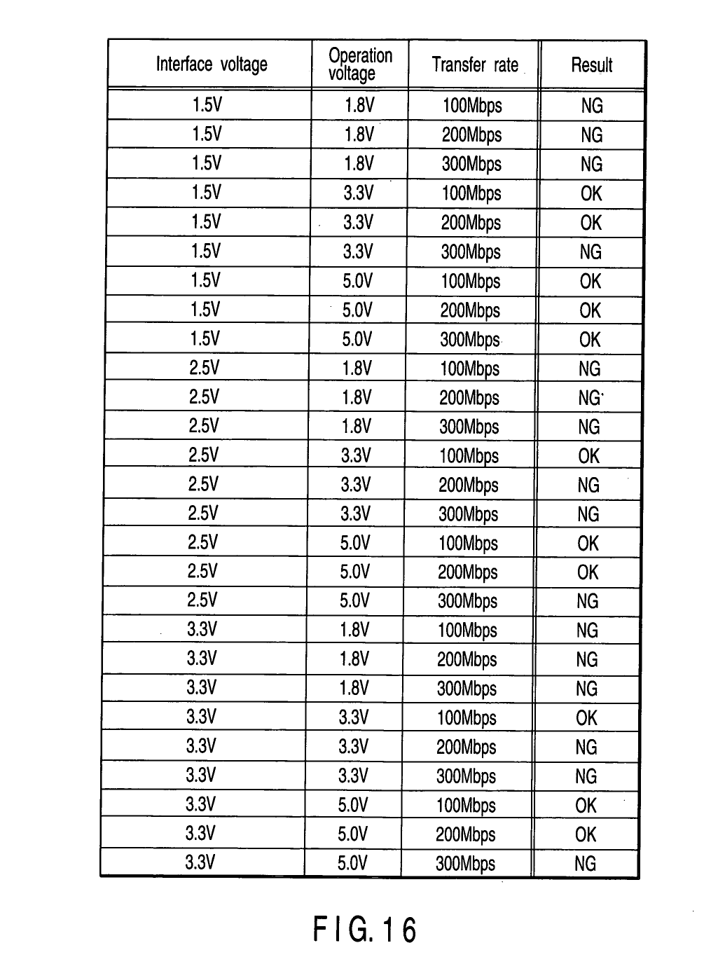

In this example, the BIOS executes operation tests for all combinations of interface voltages, operation voltages, and transfer rates to create a test result table shown in FIG. 16 (steps S701 to S704). The BIOS determines an optimal combination of the interface voltage, operation voltage, and transfer rate with reference to the test result table. In this case, the BIOS determines if the transfer rate speedup policy (speedup) or power saving policy (power saving) is to be selected (step S705). If transfer rate speedup policy (speedup) is to be selected, the BIOS selects a combination of the operation voltage and interface voltage that can realize the highest transfer rate with reference to the test result table, thus determining an optimal combination of the transfer rate, operation voltage, and interface voltage (step S706). On the other hand, if the power saving policy (power saving) is to be selected, the BIOS selects a combination of the transfer rate and interface voltage that can set the lowest operation voltage with reference to the test result table, thus determining an optimal combination of the transfer rate, operation voltage, and interface voltage (step S707).

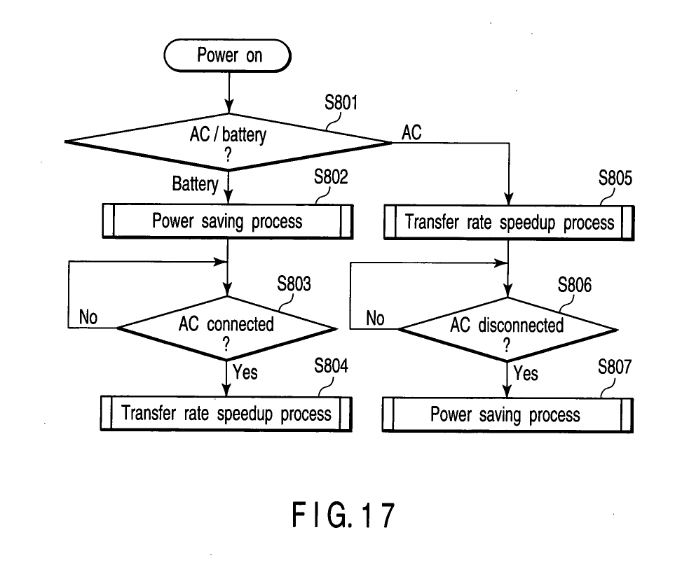

The sequence of a series of processes to be executed by the BIOS in response to power on of the computer will be described below with reference to the flowchart of FIG. 17.

When the power switch of this computer is turned on, the BIOS determines whether this computer is driven by either the AC power supply 33 or internal battery 34 by detecting if the AC power supply 33 is connected to this computer (step S801).

If this computer is driven by the internal battery 34, the BIOS executes the power saving process shown in FIG. 13 or 14 (step S802). In step S802, the transfer rate, operation voltage, and interface voltage are set to be values optimal for attaining power savings. After that, if the AC power supply 33 is connected to this computer (YES in step S803), the BIOS executes the transfer rate speedup process in FIG. 12 (step S804). In step S804, the transfer rate, operation voltage, and interface voltage are re-set to be values optimal to high-speed data transfer.

If the power switch of this computer is turned on while the AC power supply 33 is connected, the BIOS executes the transfer rate speedup process in FIG. 12 (step S805). In step S805, the transfer rate, operation voltage, and interface voltage are set to be values optimal to high-speed data transfer. After that, if the AC power supply 33 is detached from this computer (YES in step S806), the BIOS executes the power saving process shown in FIG. 13 or 14 (step S807). In step S807, the transfer rate, operation voltage, and interface voltage are re-set to be values optimal for attaining power savings.

Even when the external device 23 is connected to this computer during the operation of this computer, the BIOS executes the transfer rate speedup process or power saving process depending on the presence/absence of the AC power supply 33, and determines the operation voltage and interface voltage to be supplied to the external device 23 and device controller 22 and the transfer rate to be used in data transfer between the external device 23 and device controller 22.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. An information processing apparatus comprising:
a device controller which executes communication with an I/O device via a communication channel, the device controller including a first internal circuit and a first input/output buffer connected to the communication channel, and the I/O device including a second internal circuit and a second input/output buffer connected to the communication channel;
a power supply unit which is capable of supplying combinations of an operation power supply voltage for driving the first and second internal circuits and an interface power supply voltage for driving the first and second input/output buffers to the I/O device and the device controller;
means for executing an operation test associated with data transfer between the I/O device and the device controller with respect to a predetermined combinations of an operation power supply voltage and an interface power supply voltage; and
means for selecting one of the combinations based on a result of the operation test.

2. An information processing apparatus according to claim 1, wherein the means for selecting includes means for selecting, based on the operation test results, a combination including a lowest operation power supply voltage from such combinations of the operation power supply voltage and the interface power supply voltage that execute the data transfer normally.

3. An information processing apparatus according to claim 1, wherein the means for selecting includes means for selecting, based on the operation test results, a combination including a lowest interface power supply voltage from such combinations of the operation power supply voltage and the interface power supply voltage that execute the data transfer normally.

4. An information processing apparatus according to claim 1, wherein the means for executing includes means for executing the operation test with respect to a predetermined combinations of a transfer rate of the data transfer between the I/O device and the device controller, the operation power supply voltage, and the interface power supply voltage; and
means for selecting includes means for selecting, based on the operation test results, a combination of the operation power supply voltage and the interface power supply voltage from such combinations of the operation power supply voltage and the interface power supply voltage that execute a highest-speed data transfer.

5. An information processing apparatus according to claim 1, wherein the means for selecting includes means for selecting when there are a plurality of combinations of the operation power supply voltage and the interface power supply voltage, a combinations including a lowest interface power supply voltage from such a plurality of combinations that execute a highest-speed data transfer.

6. An information processing apparatus according to claim 1, wherein the means for executing includes means for executing the operation test in response to powering on of the information processing apparatus.

7. An information processing apparatus according to claim 1, wherein the I/O device is configured to be detachably connected to the information processing apparatus, and
the means for executing includes means for executing the operation test in response to connection of the I/O device to the information processing apparatus.

8. A power supply voltage control method of controlling an operation power supply voltage and an interface power supply voltage supplied to an I/O device and a device controller which executes communication with the I/O device via a communication channel, the device controller including a first internal circuit and a first input/output buffer connected to the communication channel, the I/O device including a second internal circuits and a second input/output buffer connected to the communication channel, an operation power supply voltage being used to drive the first and second internal circuit and an interface power supply voltage being used to drive the first and second input/output buffers, comprising:
executing an operation test associated with data transfer between the I/O device and the device controller with respect to predetermined combinations an operation power supply voltage and an interface power supply voltage; and
selecting one of the combinations based on a result of the operation test.

9. A method according to claim 8, wherein the selecting the combinations including selecting based on the operation test results, a combination including a lowest operation power supply voltage from such combinations of the operation power supply voltage and the interface power supply voltage that execute the data transfer normally.

10. A method according to claim 8, wherein the selecting the combinations including selecting based on the operation test results, a combination including a lowest interface power supply voltage from such combinations of the operation power supply voltage and the interface power supply voltage that execute the data transfer normally.

11. A method according to claim 8, wherein the executing the operation test including executing the operation test with respect to a predetermined combinations of a transfer rate of the data transfer between the I/O device and the device controller, the operation power supply voltage, and the interface power supply voltage; and
the selecting the combinations including selecting based on the operation test results, a combinations of the operation power supply voltage and the interface power supply voltage from such a combinations of the operation power supply voltage and the interface power supply voltage that execute the highest-speed data transfer.
